(19) United States
(12) Patent Application Publication
(10) Pub. No.: US 2003/0044189 A1
(43) Pub. Date: Mar. 6, 2003

(54) Transparent recordable medium, image-forming device, and recordable medium type identification device

(76) Inventors: Hiroyuki Okitsu, Kawasaki (JP); Kiyotaka Tanaka, Saitama (JP); Hidefumi Tasaki, Fukushima (JP); Hiroshi Kobayashi, Kawasaki (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/985,623

(22) Filed: Nov. 5, 2001

(30) Foreign Application Priority Data
Nov. 8, 2000 (JP) 2000-340039

(51) Int. Cl. G03G 15/00

(52) U.S. Cl. 399/45; 399/389

(57) ABSTRACT

The present invention provides a novel transparent recordable medium to be used as a genuine product for a specific image-forming device, an image-forming device and identification device that can readily and reliably identify the transparent recordable medium as any one among several types. The image-forming device comprises: a detection part that optically senses within a predetermined detection range a non-printable area on a transparent recordable medium, wherein the transparent recordable medium includes a printable area comprised of a transparent part through which light passes, and in which information is to be recorded, and the non-printable area in which recording of the information is prohibited; a printing part that performs printing on the transparent recordable medium; and a controller that determines whether the transparent recordable medium is a dedicated product expected to be exclusively used in combination with the image-forming device based upon the number of changes in value detected by the detection part within the detection range, and that enables the printing part to perform printing on the transparent recordable medium identified as the dedicated product.

### BACKGROUND OF THE INVENTION

The present invention relates generally to recordable media such as ordinary paper and other types of printing paper, and transparent sheets made of resin for use with an overhead projector or OHP (hereinafter referred to as “OHP sheet”), and image-forming devices, and more particularly to a recordable medium type identification device. The present invention is applicable preferably, for example, to an electrophotographic image-forming device that can perform printing on a transparent recordable medium whose printable area is transparent, but is not limited thereto. The “electrophotographic image-forming device” by which we mean is an image-forming device (printer, photocopier, facsimile unit, or the like) employing the Carlson process described in U.S. Pat. No. 2,297,691, as typified by a laser printer, and denotes a nonimpact printer that provides recording by depositing developer on a recordable medium.

With the recent development of office automation, the use of electrophotographic image-forming devices for computer's output devices, facsimile units, photocopiers, etc. has spread steadily. For example, multicolor laser printers provide easy operation, fast printing, and excellent printed outputs on various types and sizes of recordable media, and are expected to achieve further improvement in printing quality and rapidity in the future.

In order to improve printing quality and rapidity, printing conditions (including a conveyance condition) should be adjusted according to the types of the recordable media; e.g., ordinary paper (white paper), OHP sheets, transparent recordable media (CD labels, transparent sheets to be stuck on a pane of glass or the like), etc. For instance, the OHP sheet is of more thickness and less thermal conductivity than the white paper, and thus needs more heat for fixing. Therefore, when an OHP sheet is printed, a temperature setting for the fixing process may be changed, and a conveyance speed may be reduced. Accordingly, some of conventional laser printers provide two print modes: one for the white paper and the other for the OHP sheet, and switch the print modes according to whether the recordable media fall roughly into the white paper or the OHP sheet.

In order to identify the type of the recordable media, the conventional techniques focus on the distinction in optical properties (i.e., reflectance or transmittance of light) between the white paper and the OHP sheet. The OHP sheet is a transparent sheet through which more beams of light from an optical sensor may pass than the white paper, and thus the optical reflectance thereof is smaller than that of the white paper. Accordingly, the conventional techniques have proposed that the reflectance of the recordable medium be detected using the optical sensor, so as to make a discrimination between the white paper and the OHP sheet. If the recordable medium and the print mode turn out to be mismatched, an image-forming device, which determines so, automatically switches the print mode, otherwise raises an alarm or displays a warning to the effect and prompts a user to change the print mode manually.

The conventional image-forming devices have not been configured to determine whether the OHP sheet to be used is a dedicated product (hereinafter referred to as ‘genuine’ product) that has been specifically designed for the image-forming device and manufactured by the manufacturer of the device (or other OHP sheet suppliers), or not. Nevertheless, the print modes are generally configured to optimize a temperature in the fixing device, a driving condition of the conveyance system, and operating conditions of the other units for the genuine OHP sheet. Actually, in many instances, the image-forming devices cannot form so quality an image as desired to meet the trends toward higher image quality required in recent years, without using the genuine OHP sheet.

On the other hand, it has been difficult to make a simple discrimination between genuine and non-genuine OHP sheets. The recordable medium, in general, has a printable area on which the image-forming device can record information, and a non-printable area on which the image-forming device cannot record information. Therefore, to provide identifying information for discriminating the genuine OHP sheets from the non-genuine ones, for example, it is conceivable that the non-printable area could be painted whitely in entirety or in part. However, the image-forming device is required to convey a recordable medium at high speed to meet the recently prevailing demand for fast printing, and thus the white identifying mark should have some length enough for an optical sensor to detect. It has conventionally been difficult to form the identifying information having such a length within the non-printable area; accordingly the identifying information of which a sufficient length is secured would disadvantageously result in narrowing the printable area.

It is also conceivable, as a means for making such discrimination, that the genuine OHP sheet would be indented in part while the image-forming device is provided with a mechanical lever sensor. However, disadvantageously a small indent would be liable to produce a detection error, and formation of the indent of a large size would narrow the printable area; consequently this means for making the discrimination could not be deemed reliable.

As a result, the conventional image-forming devices cannot avoid difficulties associated with the application of the same printing conditions as for the genuine OHP sheet to the non-genuine OHP sheet, and thus would induce various problems such as a jam or like conveyance trouble, and an undesirable degradation of image quality. These problems would require a retry of the printing, loading a user with extra work. Moreover, the OHP sheets generally cost more than ordinary paper, and generation of such wasted OHP sheets due to the printing problems would also be unfavorable in view of cost efficiency.

### BRIEF SUMMARY OF THE INVENTION

Therefore, it is an exemplified general object of the present invention to provide a novel and useful transparent recordable medium, image-forming device, and recordable medium type identification device in which the above conventional disadvantages are eliminated.

To be more specific, it is an exemplified object of the present invention to provide a novel transparent recordable medium an image-forming device recognizes and uses as a genuine product, an image-forming device and identification device thereof that can simply and reliably identify the type of the transparent recordable medium.

In order to achieve the above objects, an image-forming device as one aspect of the present invention comprises: a detection part that optically senses within a predetermined detection range a non-printable area on a transparent recordable medium, wherein the transparent recordable medium includes a printable area comprised of a transparent part through which light passes, and in which information is to be recorded, and the non-printable area in which recording of the information is prohibited; a printing part that performs printing on the transparent recordable medium; and a controller that determines whether the transparent recordable medium is a dedicated product expected to be exclusively used in combination with the image-forming device based upon the number of changes in value detected by the detection part within the detection range, and that enables the printing part to perform printing on the transparent recordable medium identified as the dedicated product. This controller distinguishes a genuine transparent recordable medium from non-genuine ones, and enables the printing part to perform printing on the genuine product.

An image-forming device as another aspect of the present invention comprises: a detection part that optically senses within a predetermined detection range a non-printable area on a transparent recordable medium, wherein the transparent recordable medium includes a printable area comprised of a transparent part in which an image-forming device is allowed to record information, and through which light passes, and the non-printable area in which the image-forming device is prohibited from recording the information; and a determination part that determines whether the transparent recordable medium is a dedicated product expected to be exclusively used in combination with the image-forming device based upon the number of changes in value detected by the detection part within the detection range. The determination part can distinguish a genuine transparent recordable medium from non-genuine ones.

A transparent recordable medium as another aspect of the present invention comprises: a printable area that includes a transparent part through which light passes, and in which an image-forming device is allowed to record information; and a non-printable area in which the image-forming device is not allowed to record the information, wherein the non-printable area includes an identifying mark having reflectance 1.2 times or higher the reflectance of white paper, to indicate that the transparent recordable medium is a dedicated product expected to be exclusively used in combination with the image-forming device, wherein the reflectance of the identifying mark is detected with a light incident angle that is the same as that of the white paper. The transparent recordable medium can identify itself as a genuine product for the image-forming device with the identifying mark. The identifying mark (when measured, for example, by GretagMacbeth reflective densitometer) exhibits reflectance 1.2 times or higher the reflectance of white paper (or conventional white identifying marks).

The instant identifying mark may include at least three portions of a reflective portion, a transparent portion, and another reflective portion, arranged in this sequence along a straight line, wherein each reflective portion has reflectance 1.2 times or higher the reflectance of white paper. Thanks to the high reflectance of the reflective portion, the identifying mark can be detected by an optical sensor or the like even if the at least three portions are arranged in the non-printable area along a straight line (e.g., a straight line parallel to the direction of conveyance in the image-forming device) in the sequence of the reflective portion having reflectance 1.2 times or higher the reflectance of white paper, the transparent portion, and the same reflective portion. Accordingly the reflective portion serves to increase an amount of information in the non-printable area that conventionally includes merely solid white image information. The reflective portion that need not be formed in the printable area would never narrow the printable area. Moreover, the reflective portion may be embodied as two stripes that are, for example, perpendicular or diagonal to the above straight line, or a circular band. The reflective portion may also be formed only in part of the non-printable area. Accordingly, the reflective portion and the transparent portion may retain a high degree of flexibility in arrangement.

Other objects and further features of the present invention will become readily apparent from the following description of the embodiments with reference to accompanying drawings.

### BRIEF DESCRIPTION OF THE DRAWINGS

FIG. 1 is a partially enlarged plan view that schematically illustrates a first embodiment of a genuine OHP sheet according to the present invention.

FIG. 2 is a partially enlarged plan view that schematically illustrates a second embodiment of the genuine OHP sheet according to the present invention.

FIG. 3 is a partially enlarged plan view that schematically illustrates a third embodiment of the genuine OHP sheet according to the present invention.

FIG. 4 is a graph for showing reflectance of an identifying mark used for the OHP sheet of the present invention as shown in FIGS. 1-3 in comparison with that of a transparent portion and white paper.

FIG. 5 is a schematic sectional view of an image-forming device as an exemplified embodiment of the present invention.

FIG. 6 is a schematic sectional view of the image-forming device as shown in FIG. 5 illustrated with a part thereof near an OHP sensor enlarged.

FIG. 7 is a block diagram for explaining a control system of the image-forming device as shown in FIG. 5.

FIG. 8 is a schematic enlarged section for illustrating an arrangement of the OHP sensor for use with the image-forming device as shown in FIG. 5, and a sheet P.

FIG. 9 is a diagram for illustrating relative positions of a register roller, an OHP sensor, and a register sensor in the image-forming device as shown in FIG. 5.

FIG. 10 is a schematic sectional view of part of the image-forming device for explaining functions of an open/close guide as shown in FIG. 5.

FIG. 11 is another schematic sectional view of part of the image-forming device for explaining functions of the open/close guide as shown in FIG. 5.

FIG. 12 is a diagram for explaining an exemplified method of determining an OHP sensor output in the image-forming device as shown in FIG. 5.

FIG. 13 is a timing chart for sensors and motors when the sensors detect a sheet fed from a cassette in the image-forming device as shown in FIG. 5.

FIG. 14 is a timing chart for sensors and a motor when the sensors detect a sheet fed from an MFF in the image-forming device as shown in FIG. 5.

FIG. 15 is a flowchart showing a control by a controller in the image-forming device as shown in FIG. 5 when a sheet is detected.

FIG. 16 is an exemplified output signal waveform of the sensors in the image-forming device as shown in FIG. 5.

### DETAILED DESCRIPTION OF THE INVENTION

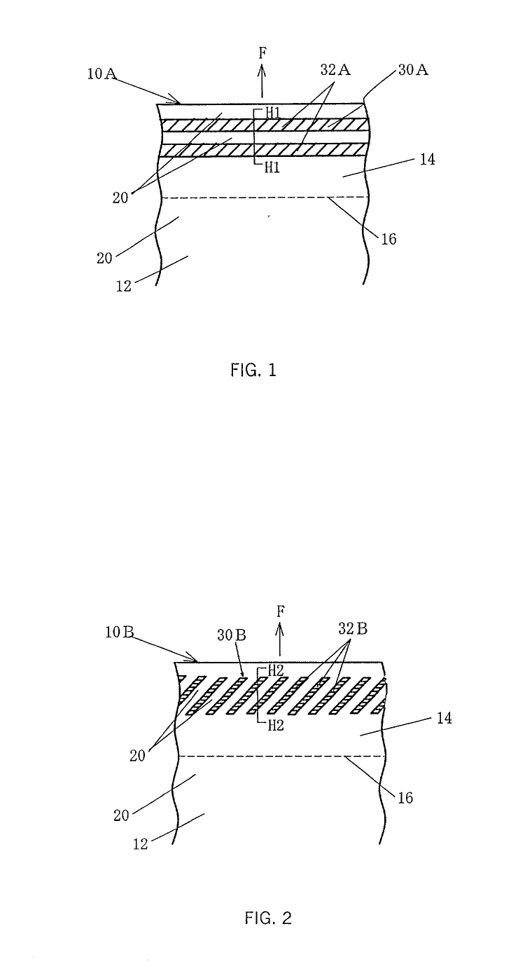

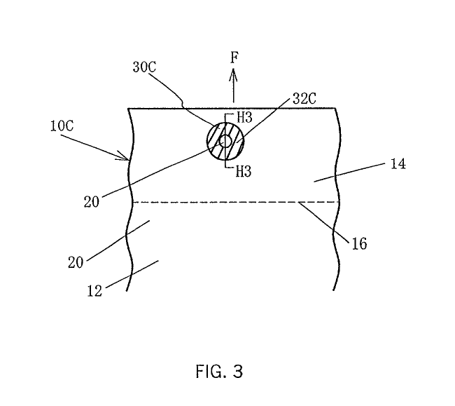

Referring now to the drawings, a description will be given of genuine (-product) OHP sheets (or those for exclusive use) 10A through C (hereinafter, these elements are comprehensively indicated by a reference numeral ‘10’, unless otherwise specified) including identifying marks 30A through C (hereinafter, these elements are comprehensively indicated by a reference numeral ‘30’, unless otherwise specified). FIG. 1 is a partially enlarged plan view that schematically illustrates a first embodiment of the genuine OHP sheet 10A according to the present invention. FIG. 2 is a partially enlarged plan view that schematically illustrates a second embodiment of the genuine OHP sheet 10B according to the present invention. FIG. 3 is a partially enlarged plan view that schematically illustrates a third embodiment of the genuine OHP sheet 10C according to the present invention. In each figure, those elements designated by the same reference numerals denote the same elements, and a duplicate description thereof will be omitted.

Referring to FIGS. 1 through 3, the genuine OHP sheet 10 of the present invention is, in common, includes a printable area 12 that is generally rectangular and on which an image-forming device 100 that will be described later can record information, and a non-printable area 14 on which the image-forming device 100 is prohibited from recording information. A rectangular contour of the printable area 12 is defined with a borderline 16, which is shown in FIGS. 1 through 3, but invisible in actuality. The non-printable area 14 is formed as a margin surrounding the printable area 12. The printable area 12 includes a transparent portion 20 through which light may pass. The non-printable area 14 includes an identifying mark 30 for indicating that the OHP sheet 10 is a genuine product for the image-forming device 100. The transparent portion 20 is a transparent sheet made of resin used for white-and-black printing, but may be substituted by a transparent sheet made of resin used for multicolor printing with a surface thereof coated to acquire improved coloring of multicolor toner. Through the transparent portion 20, most light may pass. To be specific, some of the light emitted to the transparent portion 20 may be reflected specularly, but the most of the light may pass through the transparent portion 20. Since the transparent portion 20 may be manufactured using techniques known in the art, a detailed description will be omitted.

The OHP sheet 10 includes an identifying mark 30 in the non-printable area 14. The identifying mark 30 serves not only to distinguish the OHP sheet 10 from white paper, but also to distinguish the OHP sheet 10 from non-genuine OHP sheets. Resultantly, the identifying mark 30 enables the image-forming device 100 to be configured to provide desired printing conditions, and to form a desired quality image on the OHP sheet 10.

The identifying mark 30 differs in identifying the OHP sheet 10 as a genuine product for the image-forming device 100 from a mark for identifying a face of the OHP sheet 10. The OHP sheet 10 has the face or printing surface (on which the image-forming device 100 performs printing) coated to enhance transmittance of light from the projector, and thus when the OHP sheet 10 inadvertently turned upside down is fed to the image-forming device 100, the coated surface would disadvantageously fail to peel off and become tangled with the fixing roller, causing a jam or other conveyance troubles.

The identifying mark 30 is formed on the non-printing surface (or back) of the OHP sheet 10. As will be described later, the identifying mark 30 exhibits reflectance 1.2 times or higher the reflectance of white paper, when light is emitted from the face side of the OHP sheet 10, while the identifying mark 30 exhibits reflectance less than 1.2 times, or preferably lower than, the reflectance of white paper, when light is emitted from the back surface side of the OHP sheet 10. This is because a face of the identifying mark 30 is not mirror-finished, and exhibits lowered reflectance when light is emitted from the back surface side of the OHP sheet 10 directly on the face of the identifying mark. In this way, the inventive OHP sheet 10 serves to identify the face thereof using such differentiated reflectance between the face and the back surface.

In the present embodiment, the identifying mark 30 is formed in a top margin of the non-printable area 14 of the OHP sheet 10. To be more specific, a user places the OHP sheet 10 into the image-forming device 100 so that the identifying mark 30 is positioned in front with respect to a forward direction of conveyance F in the present embodiment. Since the OHP sheet 10 is conveyed from the top margin in the forward direction of conveyance F by the image-forming device 100, the identifying mark 30 in the present embodiment serves to indicate the top margin of the OHP sheet 10. Alternatively, the identifying mark 30 may be formed in a left and/or right margin of the non-printable area 14 of the OHP sheet 10. The image-forming device 100 should identify the OHP sheet 10 and determine the print mode as soon as possible, and thus the identifying mark 30 is preferably formed in any margin other than a rear margin of the non-printable area 14 as the rear margin is the last to be conveyed among other portions of the OHP sheet 10. In other words, it is not preferable in the present embodiment that a user places the OHP sheet 10 with the identifying mark 30 positioned in rear with respect to the forward direction of conveyance F in the image-forming device 100.

A reflective portion 32 is formed with a silvery paint printed on the OHP sheet 10, and a contact surface of the reflective portion 32 with the OHP sheet is mirror-finished of itself. Nevertheless, the color of the reflective portion 32 is not limited to silver, but may be golden, bluish, glossy, and matte.

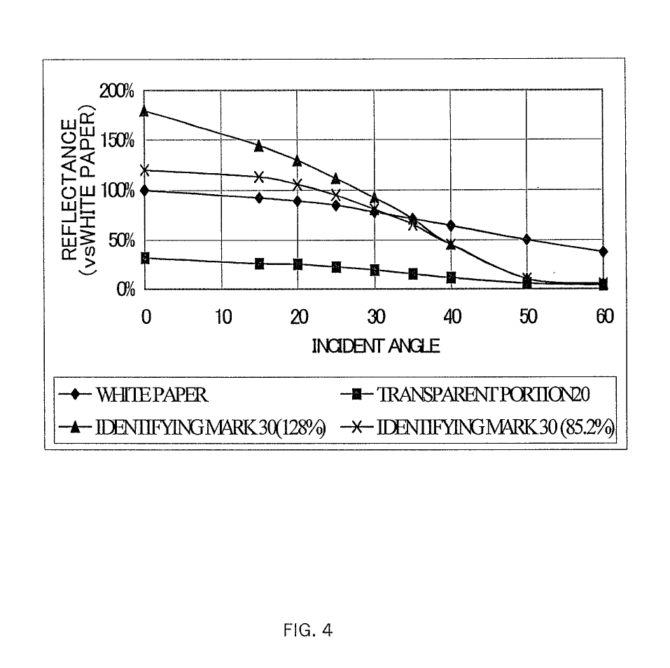

The reflective portion 32 of the identifying mark 30 has reflectance 1.2 times or higher the reflectance of white paper when light is emitted from the face side of the OHP sheet. In the present embodiment, the white paper exhibits the reflectance of 71%, which is measured by GretagMacbeth reflective densitometer PCM-II (with wavelength of 950 nm). FIG. 4 shows a relationship between an (a light) incident angle and reflectance for two types of the identifying marks 30 (reflectance: 128% and 85.2% each), the transparent portion 20, and the white paper. The incident angle herein denotes an angle formed by an axis perpendicular to the sheet with the sensor. In addition, each reflectance of the identifying marks 30 is measured under the same conditions (sheet angle=0), on which the identifying marks 30 respectively exhibit 1.8 and 1.2 times the reflectance of the white paper. It is understood from the drawing that the identifying mark 30 with the reflectance of 85.2% should have the sheet angle within the range from 0 to 15 degrees in order to secure 1.2 times or higher the reflectance of the white paper. It is also understood that the identifying mark 30 with the reflectance of 128% should have the sheet angle within the range from 0 to 25 degrees.

The identifying marks may assume various shapes. For instance, an identifying mark 30A is constructed of a reflective portion 32A in two separate stripes substantially perpendicular to the direction of conveyance F. An identifying mark 30B is constructed of a reflective portion 32B in a plurality of stripes diagonal to the direction of conveyance F. An identifying mark 30C is constructed of a reflective portion 32C in the shape of a circular band.

In the present embodiment, as shown in FIGS. 1-3, every identifying mark 30 includes a reflective portion 32, a transparent portion 20, and another reflective portion 32 arranged respectively in optical sensor detection ranges H1-H1, H2-H2, and H3-H3 (not shown; generally indicated by ‘H-H’, unless otherwise specified) along a straight line parallel to the direction of conveyance F. Assume that the reference numeral ‘32’ herein comprehensively designates 32A through C, unless otherwise specified.

Even though the transparent portion 20 and the reflective portions 32 were arranged in the above manner along a straight line parallel to the direction of conveyance F in the non-printable area 14, the high reflectance of the reflective portions 32 would allow the optical sensor in the image-forming device 100 to detect reflection two times, when these portions are chosen as detection ranges. Accordingly, the reflective portion 32 serves to increase an amount of information in the non-printable area that conventionally includes merely such a solid white image that the optical sensor could not detect reflection just once. Needless to say, two-time detection of reflection is a minimum requirement, and the number of the reflective portions 32 that may alternate with the transparent portions 20 is not limited to two. Further, each reflective portion 32 may vary in width as a bar code so as to include more information.

The amount of information in the non-printable area 14 may be enhanced by other than the two-time detection of reflection. The non-printable area 14 may embrace various types of information (e.g., an identifying mark including a specified number of reflective portions may be formed in the left and/or right margins of the printable area 14 of the OHP sheet 10). Therefore, the non-printable area 14 may include, if required, other than the identifying mark 30 for discriminating a genuine product, an identifying mark for discriminating between the sheet for black-and-white printing and that for multicolor printing, an identifying mark for specifying print modes, an identifying mark for specifying product information (e.g., manufacturer, date of manufacture, lot of manufacture), and the like. Moreover, the identifying mark 30 does not extend beyond the printable area 12, and thus would not narrow the printable area 12.

The identifying mark 30 may be formed essentially in a position where the optical sensor (not shown in FIGS. 1-3) may detect the same, and is not required to cover the whole printable area 14. For instance, if the optical sensor is placed above in a range between 2 and 4 cm of distances from the left edge of the OHP sheet 10, the identifying mark 30 may be placed only in the range.

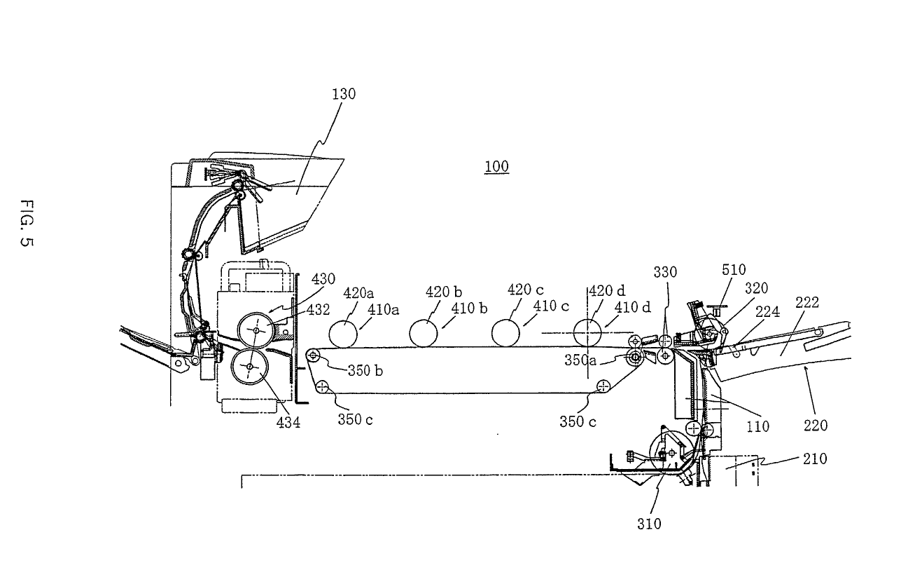

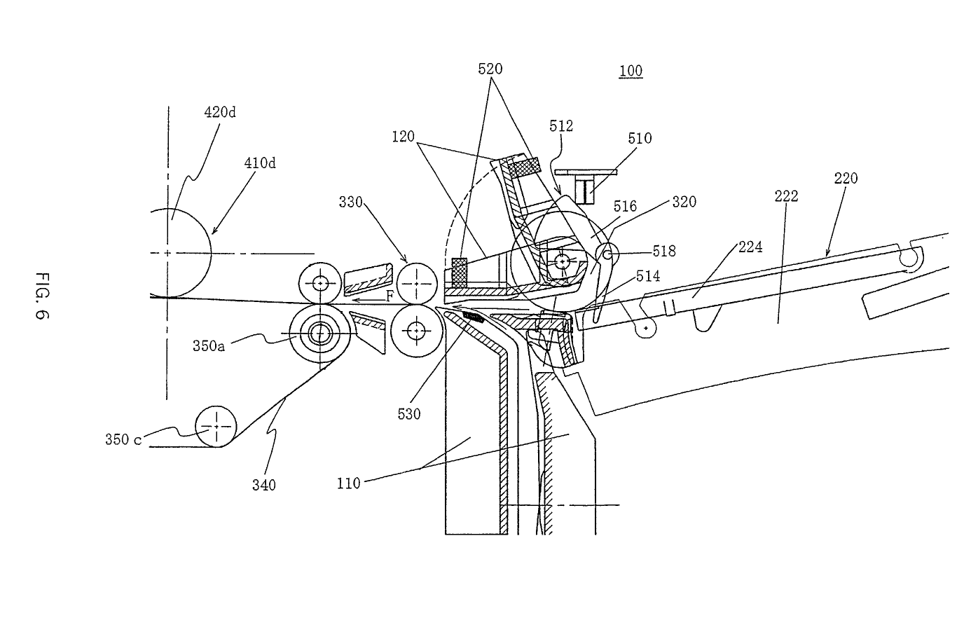

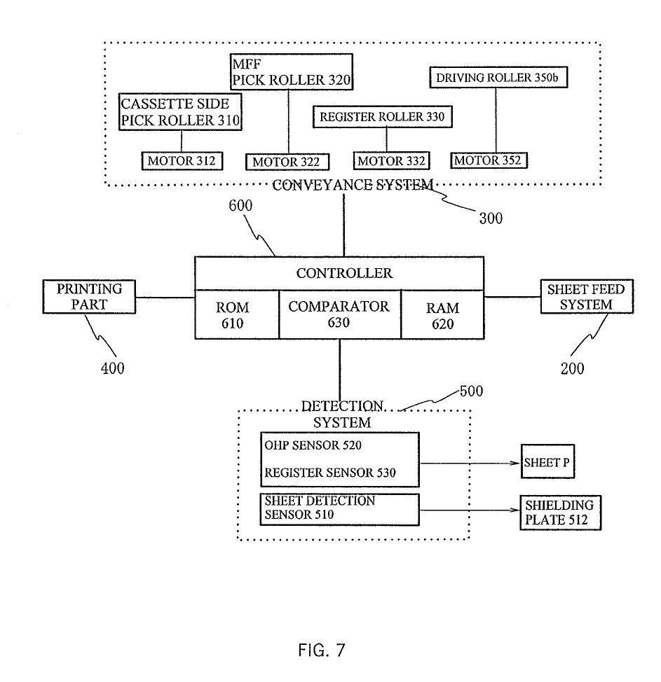

With reference to the drawings, a description will now be given of a structure of an image-forming device 100 as one exemplified embodiment of the present invention. FIG. 5 is a schematic sectional view of the image-forming device 100 as an exemplified embodiment of the present invention. FIG. 6 is a schematic sectional view of the image-forming device 100 as shown in FIG. 5, illustrated with a part thereof near an OHP sensor 520 enlarged. FIG. 7 is a block diagram for explaining a control system of the image-forming device 100 as shown in FIG. 5. The image-forming device 100 includes a sheet feed system 200, a conveyance system 300, a printing part 400, a detection system 500, a controller 600.

The sheet feed system 200 includes a cassette 210 and an MFF (multifunction feeder) 220. The sheet feed system 200 feeds a sheet P from the cassette 210 and MFF 220 as a sheet placement part to the conveyance system 300 that will be described later. As the image-forming device 100 in the present embodiment can characteristically discriminate among white paper, a genuine OHP sheet, and a non-genuine OHP sheet, the sheet P is either of them.

The cassette 210 is a housing in which a plurality of sheets P are stored, and more specifically includes a table on which the sheets P are stacked. The cassette 210 is detachably attached to a main body of the image-forming device 100, and for example molded in plastic. The cassette 210 accommodates, for example, approximately 100 through 500 sheets P, if the sheets P are white paper. The image-forming device 100 may be equipped with a plurality of cassettes for usable sizes of the sheet P, or one cassette capable of the sheet P of a variety of sizes. A topmost sheet of the sheets P placed in the cassette 210 is brought into contact with a pick roller 310 at the cassette side.

The cassette 210 preferably includes an empty sensor for detecting a loss of sheets, and a pressing means for pressing the table on which the sheets P are placed toward the pick roller 310 so as to keep the topmost sheet of the sheets P in contact with the pick roller 310. A tray may be used instead of the cassette 210 in the image-forming device 100.

The MFF 220 provides a place for a sheet unfit to be stored in the cassette 210 for continuous printing, or a sheet of less frequency in use. The sheet P to be placed in many instances on the MFF 220 may include, for example, an OHP sheet, a transparent sheet, a T-shirt, CD (Compact Disk) label, and a cardboard, but a sheet of ordinary (white) paper may also be placed thereon. The MFF 220 is equivalent to a manual document feeder (MDF) equipped in the commonest image-forming devices, and exerts the same operations and advantageous effects as the MDF. The MFF 220 includes a table 222, and a pressure plate 224.

On the table 222 is placed one or more of sheets P. The pressure plate 224 is provided at a bottom of the table 222. The pressing means (not shown) such as a spring presses the pressure plate 224 toward a pick roller 320, and consequently the topmost sheet is brought into contact with the pick roller 320. The table 222 is molded, for example, of plastic. The table 222 has a rectangular shape having an area in which part or entirety of the sheets may be placed. Referring to FIGS. 5 and 6, the table 222 is a little slanted off the horizontal, and thereby an end portion at the pick roller side of the sheets P is kept in constant contact with the pick roller 320.

The MFF 220 may be configured to be detachable from the image-forming device 100. Detaching the MFF 220 when unused would eliminate a projection due to the MFF 220 from the image-forming device 100. The MFF 220 may also be configured to be bendable by using a hinge part or the like. This configuration would prevent the MFF 220 when unused from being projected from the image-forming device 100, and serve to maintain a neat appearance of the sides of the image-forming device 100.

The conveyance system 300, which conveys a sheet P from the sheet feed system 200 to a sheet output part at predetermined intervals, includes a cassette side pick roller 310, an MFF pick roller 320, and a register roller 330.

The cassette side pick roller 310 is connected with a motor 312 or other driving means, and pivotably mounted. The motor 312 is electrically connected with the controller 600, and driven under the control of the controller 600. Rotatory and frictional forces of the pick roller 310 that rotates counterclockwise in FIGS. 5 and 6 feeds the sheets P placed in the cassette 210 forward (in the direction of conveyance F). Therefore, the pick roller 310 may preferably be selected among those made of materials having a high coefficient of friction, such as rubber.

The MFF pick roller 320 is a roller pivotably mounted to feed the sheet P placed on the table 222 to the printing part 400. The MFF pick roller 320 is connected with a motor 322 or other driving means. The motor 322 is electrically connected with the controller 600, and driven under the control of the controller 600. Rotatory and frictional forces of the MFF pick roller 320 that rotates counterclockwise in FIGS. 5 and 6 feeds the sheets P on the table 222 forward (in the direction of conveyance F). Therefore, the pick roller 320 may preferably be selected among those made of materials having a high coefficient of friction. The pick roller 320 basically as efficient as the cassette side pick roller 310 as described above.

The register roller 330 is disposed between the printing part 400 and the cassette side pick roller 310 (or the MFF pick roller 320) on a conveyance path of the sheets P. The register roller 330 includes a pair of rollers rotating in opposite directions, and conveys the sheet P in the direction of conveyance F. The register roller 330 is connected with a motor 332 or other driving means, and pivotably mounted. The motor 332 is electrically connected with the controller 600, and driven under the control of the controller 600.

The register roller 330 serves to temporarily suspend the sheet P conveyed from the cassette side pick roller 310 and the MFF pick roller 320, to provide a properly timed feed of the sheet P to the printing part 400 (the photosensitive drum 420 thereof), and to place an image to be printed at a desired position on the sheet P. The register roller 330 also serves to correct an oblique feed (or skew) of the sheet P to the direction of conveyance F. Further, the register roller 330 serves to synchronize a conveyance speed of the sheet P with a circumferential velocity (of the photosensitive drum 420) in the printing part 400 which may vary with the print modes. Therefore, the register roller 330 may preferably have the pair of rollers sufficiently pressurized so as not to allow the sheet P to slip out of registration.

The conveyance system 300 includes a conveyor belt 340 that conveys the sheet P from the register roller 330 to subsequent steps, and other elements. These elements are provided to receive the sheet P from the register roller 330 and to convey the same along the sheet conveyance path (in the direction of conveyance F) to a fixer 430 in the printing part 400. While the conveyor belt 340 conveys the sheet P, the printing part 400 forms a toner image (transferring toner) on the sheet P. The conveyance belt 340 is an endless belt, which is sandwiched between the photosensitive drum 420 in each process unit 410 and a corresponding transfer roller (not shown), and rotates to the left (counterclockwise).

The conveyor belt 340 is made of a permeable dielectric material such as a synthetic resin. The conveyor belt 340 rotates and moves by torque of the photosensitive drum 420 that will be explained later, force (pressing force) of the transfer roller against the photosensitive drum 420, and torque of a driving roller 350b. The sheet P conveyed from the register roller 330 is electrostatically adsorbed to the conveyor belt 340, and thus moves at the same speed as a moving speed of the conveyor belt 340 without slipping out of proper position. Therefore, the sheet P adsorbed on the conveyor belt 340 is pressed to the photosensitive drum 420 by the transfer roller, and thus the sheet P and the photosensitive drum may easily be brought into intimate contact with each other, whereby a high-quality transferred image is obtained. Like this, the conveyor belt 340 closely relates to the transfer process, and therefore may be called a transfer belt too. The conveyor belt 340 also serves to convey the sheet P at a constant speed in each process unit 410. On a bottom belt surface of the conveyor belt 340 preferably is provided a sensor (not shown) perpendicular to a belt-moving direction. The sensor optically reads a register mark on the conveyor belt 340, and detects a misalignment of the conveyor belt 340.

The conveyor belt 340 is provided with a roller 350 for driving the belt to rotate. The roller 350 comprises a driven roller 350a, a driving roller 350b, and a guide roller 350c, and serves to rotate the conveyor belt 340 (hereinafter the reference numeral ‘350’ comprehensively designates these rollers, unless otherwise specified). A top side of traveling portion of the conveyor belt 340 between the driven roller 350a and the driving roller 350b forms a conveyance path of the sheet P. The driving roller 350b is connected with a motor 335 or other driving means, and thereby driven to rotate. The motor 335 is electrically connected with the controller 600, and timely driven under the control of the controller 600. Consequently, the conveyor belt 340 rotates at a predetermined circumferential velocity, so that the printing part 400 may perform printing.

The conveyance system 300 further includes a roller (not shown) or the like, to convey the sheet P from the fixer 430 to an ejection part. Since this mechanism may be realized, for instance, by using a pair of rollers rotating in opposite directions as the resister roller 330, a detailed description will be omitted herein.

The printing part 400 includes four process units 410a through 410d (hereinafter the reference numeral ‘410’ comprehensively designates these elements, unless otherwise specified), and a fixer 430.

The process unit 410 serves to form (transfer) a desired toner image on the printable medium P. The four process units 410a through 410d and the fixer 430 are aligned in a straight line. The process unit 410 includes a photosensitive drum 420, components that is not illustrated in the drawings such as transfer rollers, a pre-charger, an exposure device, a development device, a cleaning part, and a screw conveyor. Particular attention should be paid to the fact that the process units 410a through 410d as shown in FIG. 5 have different transfer rollers (each having different pressing force).

The present embodiment employs four colors of black (K), cyan (C), magenta (M), and yellow (Y), which are respectively allotted to the process units, i.e., black (K) to the process unit 410a, cyan (C) to the process unit 410b, magenta (M) to the process unit 410c, and yellow (Y) to the process unit 410d. It is to be understood that the number of colors in the present invention is not limited to four. In addition, when the process unit 410 performs printing on an OHP sheet, it is apparent from its actual application that single-sided printing is performed. However, when the process unit 410 in the present embodiment performs printing on white paper, no restriction is put on application to both single-sided and double-sided printing. For black and white printing, only the process unit 410 using black toner is provided.

The photosensitive drum 420 includes a photosensitive dielectric layer on a rotatable drum-shaped conductor support, and is used for an image holding member. The photosensitive drum 420, which is, for instance, made by applying a function separation-type organic photoreceptor with a thickness of about 20×10⁻⁶ m on a drum made of aluminum, has an outer diameter of 30 mm, and rotates at a circumferential velocity of 70 mm/s. The pre-charger is, for instance, comprised of a corona-electrifying device or scorotron-electrifying device, and gives a constant amount of electric charges (e.g., about −700 V) on the photosensitive drum 420.

The exposure device includes, for instance, an LED array as an optical writing unit. When the light is irradiated and scans by the LED array on the photosensitive drum 420, the uniform charge at the irradiated area on the photosensitive drum 420 corresponding to the image is eliminated through exposure to light, and an electrostatic latent image is formed. To be more specific, light-emitting devices arranged in a main scanning direction of the LED array is driven according to the levels of tone of imaging data (dot data) converted from image data provided as printing information from a host device such as a computer, and a word-processor. Consequently, the electrostatic latent image is written as a dot image.

The development device serves to visualize a latent image formed on the photosensitive drum 420 into a toner image. The development device includes a development roller, a reset roller, and a toner cartridge. In the present embodiment, toner of four colors such as yellow (Y), magenta (M), cyan (C), and black (K) is used for a developing agent as an example. The developing agent may include one or two components (i.e., it may include a carrier) without distinction as to whether it is magnetic or nonmagnetic. The toner cartridge stores toner and supplies toner to the reset roller. The reset roller comes into contact with the development roller, and supplies toner to the development roller. The development roller is placed in or out of contact with the photosensitive drum 420, and supplies toner to the photosensitive drum 420 by electrostatic force. Consequently, a toner image is formed on the photosensitive drum 420. Unused toner remaining on the development roller is collected by the reset roller and brought back into the toner cartridge.

The transfer roller generates an electronic field to electrostatically adsorb toner, and transfers the toner image adsorbed on the photosensitive drum 420 onto a sheet P. The transfer roller is, as shown in FIG. 5, opposed to the photosensitive drum 420 through the conveyor belt 340. The transfer roller 150 is also disposed to press the conveyor belt 340 to the photosensitive drum 420 by a pressing mechanism (not shown). Therefore, when a sheet P is conveyed to a transfer position by the conveyor belt 340, the above pressing mechanism is actuated, and presses the transfer roller to the photosensitive drum 420. This pressing force with torque of the photosensitive drum 420 and driving force of the driving roller 350b would initiate the rotation and movement of the conveyor belt 340.

The cleaning part collects and disposes of toner remaining on the photosensitive drum 420 after the transfer process, or as necessary returns the toner collected by the screw conveyor to the toner cartridge. The cleaning part also serves to collect debris on the photosensitive drum 420. The cleaning part may utilize varied kinds of means including magnetic force and rubber friction to remove the toner and charges on the photosensitive drum 420.

The fixer 430 serves to permanently fix a toner image (toner layer) onto a sheet P. The fixer 430 includes an upper fixing roller 432, and a lower fixing roller 434, and the sheet conveyance force is produced by the upper fixing roller 432 and the lower fixing roller 434. The upper fixing roller 432 and the lower fixing roller 434 are disposed parallel to and in contact with each other, and a nip N is formed therebetween. Materials used for the fixing rollers 432 and 434 vary with the uses, and fluorocarbon rubber, silicone rubber, or the like may be employed. The upper fixing roller 432 and the lower fixing roller 434 incorporate a halogen lamp or the like as a heating source, and may produce heat, for instance, to 170° C. through 190° C. A thermistor (not shown) is provided to detect surface temperature on the rollers 432 and 434. In addition, a high pressure, for example, at 33 atm is applied between the upper fixing roller 432 and the lower fixing roller 434. Toner transferred onto a sheet P is fixed by the high temperature and high pressure. To be more specific, the transferred toner is adhered onto a sheet P only with a weak force, and thus easily fallen off. Therefore, the fixer 430 fuses the toner by pressure and heat to imbue the sheet P with the toner. Energy required to fix the toner layer for a multicolor image formation is greater than that for a single-color image formation. To a stacker or ejection part, the sheet P is dispensed out after printing is completed.

The detection system 500 includes an MFF sheet detection sensor 510, an OHP sensor 520, and a register sensor 530.

The MFF sheet detection sensor 510 serves to detect whether sheets P are placed on the table 222, in cooperation with a shielding plate 512. The MFF sheet detection sensor 510 is a light transmission type photointerrupter having a light-emitting part and a light-receiving part (neither shown). The MFF sheet detection sensor 510 is configured to allow the shielding plate 512 to pass between the light-emitting part and the light-receiving part. Light emitted from the light-emitting part is input to the light-receiving part, and converted into a digital signal. The MFF sheet detection sensor 510 is connected with the controller 600 that will be described later, and the digital signal is processed and controlled in the controller 600. For the light-emitting part is used an LED (light-emitting diode), and for the light-receiving part are used a phototransistor, a photo IC, a photodiode, or the like.

The shielding plate 512 is comprised of a first plate 514 and a second plate 516. Each of the first plate 514 and the second plate 516 may be an independent component, but may preferably be formed in one component. The first plate 514 and the second plate 516 are thin plate-shaped members, and molded, for instance, of plastic. The shielding plate 512 is rotatably supported on a pivot point at an interface between the first plate 514 and the second plate 516. The second plate is preferably formed with an outer edge portion wide. As will be discussed later, the second plate 516 serves to shield light. The wide outer edge portion could securely cover an area to be shielded, even if more than one sheet P is placed.

Referring to FIG. 6, when no sheet P is placed on the table 222, the first plate 514 of the shielding plate 512 has an end portion grooved in a recess (not shown) on the table 222. On the other hand, an end portion of the second plate 516 is positioned near the MFF sheet detection sensor 510 (immediately to the left of the MFF sheet detection sensor in the drawing). When the sheets P are placed on the table 222, the inserted sheets P rotate the first plate 514 clockwise about the pivot point 518. The second plate 516 is synchronized with the movement of the first plate 514 and rotates clockwise in the same fashion. As the second plate 516 rotates, the second plate 516 passes between the light-emitting part and light-receiving part of the sensor 510. Accordingly, a beam of light from the light-emitting part of the sensor 510 is shielded, and thus the sensor 510 generates an OFF signal whereby placement of the sheets P is detected. Although the shielding of a beam of light by the shielding plate 512 makes the sensor 510 generate an OFF signal in the present embodiment, the sensor 510 may generate an ON signal when the shielding plate 512 shields the beam, and an OFF signal when the shielding plate 512 is away. Although an optical sensor is used for the sensor 510, usable sensors are not limited thereto.

The OHP sensor 520 is provided at an end portion of an open/close guide 120 that will be described later. The OHP sensor 520 is a light reflection type photointerrupter that identifies the type of the sheet P (as any one among white paper, a genuine OHP sheet, and a non-genuine OHP sheet, in the present embodiment). The OHP sensor 520 may also discriminate between the sheets P for black-and-white printing and for multicolor printing, between white paper and colored paper, or the like. The light reflection type photointerrupter includes a light emitting part and a light receiving part (neither shown) as the light transmission type photointerrupter does. In the light reflection type photointerrupter, a beam of light emitted from the light emitting part is reflected off a medium, and received by the light receiving part. The OHP sensor 520 electrically outputs a signal corresponding to the intensity of the beam received by the light receiving part.

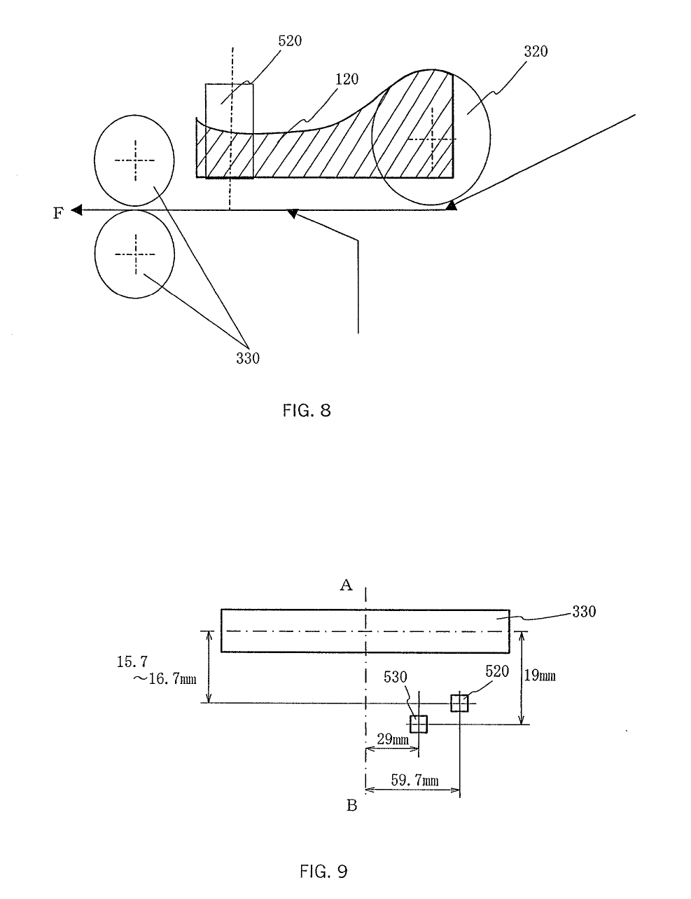

Referring to FIG. 8, in a closing position of the open/close guide 120 that will be described later, the OHP sensor 520 is preferably disposed so that a beam of light thereof may be emitted in a direction substantially perpendicular to the sheet P that is being conveyed. FIG. 8 is a schematic enlarged section for illustrating an arrangement of the OHP sensor 520 for use with the image-forming device 100 as shown in FIG. 5, and a sheet P. The OHP sensor 520 may be shifted within the range of 10 degrees ahead and behind the reference position. This range of the position allows the OHP sensor to detect reflectance of the identifying mark 30 on the genuine OHP sheet 10 as described above, as is 1.2 times the reflectance of white paper, as shown in FIG. 4.

The OHP sensor 520 is electrically connected with the controller 600, and information from the OHP sensor 520 is handled in the controller 600. The information from the light receiving part of the OHP sensor 520 is judged to be high or low according to the electrical intensity in the controller 600. The OHP sensor 520 may be provided in a guide 110. The OHP sensor 520 may detect from upper side and/or lower side of the sheet P.

The register sensor 530 is provided on the conveyance path of the sheet P. The register sensor 530 is, for instance, an optical sensor, and detects that the sheet P has come in the conveyance path. Usable sensors are not limited to the optical sensor on the premise that the sensors can detect that the sheet P has come in the conveyance path. The register sensor 530 is electrically connected with the controller 600. The output signal from the register sensor 530 is handled in the controller 600. The information from the receiving part of the register sensor 530 is judged to be high or low according to the electrical intensity in the controller 600. In the present invention, the output signal from the register sensor 530 is preferably judged to be high when the sheet P is conveyed and passes through the register sensor 530. In addition, the information from the register sensor 530 is also used as information for timely conveying the sheet P to the printing part 400. Moreover, it is conceivable no OHP sensor 520 is provided and the register sensor 530 serves as the OHP sensor 520 too.

Referring now to FIG. 9, the OHP sensor 520 and the register sensor 530 are arranged as in the FIG. 9. FIG. 9 is a diagram for illustrating relative positions of the register roller 330, the OHP sensor 520, and the register sensor 530 in the image-forming device 100 as shown in FIG. 5. As shown in the drawing, the register sensor 530 is positioned behind the OHP sensor 520 on the conveyance path. The OHP sensor 520 is preferably disposed as shown in FIG. 9 irrespective of where the open/close guide 120 or the guide 110 is located. However, the values shown in FIG. 9 are exemplary, and the value applicable to the present invention is not limited thereto. The OHP sensor 520 and the register sensor 530 may be disposed symmetrically with respect to a central line (line AB) of the conveyance path.

Referring again to FIG. 7, a description will be given of the controller 600 of the inventive image-forming device 100. The controller 600 includes, for instance, a CPU or MPU (not shown), a ROM 610, a RAM 620, a comparator 630, and the like. The ROM 610 stores a basic program (e.g., a firmware) required for operations of the image-forming device 100. Particularly in the image-forming device 100 according to the present invention, the ROM 610 further stores various print modes, an operation program for printing and conveyance operations in accordance with one of the print modes, and basic sizes of sheets, etc. The print modes of the inventive image-forming device 100 are three: those for white paper, a genuine OHP sheet, and a non-genuine OHP sheet, and the first two modes define conditions including the conveyance conditions and the fixing conditions, while the mode for the non-genuine OHP sheet directs a print suspension to exclude the non-genuine OHP sheet from media to be printed. However, these print modes are exemplary, and various print modes are applicable, which are capable of fitting multicolor printing, black-and-white printing, cardboards, colored sheets, and the like, in details. The printing and conveyance conditions for each mode stored in the controller 600 are to be predetermined through prior experiments, so that printing can be performed in an optimal condition on a specific sheet P. The controller 600 arbitrarily selects the optimal mode for the specific sheet P the type of which is determined by detection operations that will be described later, and enables optimal printing. The RAM 620 temporarily stores part of data such as in the ROM 610.

The comparator 630 compares an electric signal sent from each sensor with a reference value (slice level). Accordingly, the output signal from each sensor comes in the comparator 630. The controller 600 recognizes the signals less and more than the slice level respectively as being low and high by receiving specified electrical signals through the comparator 630. The comparator 630 is a circuit realized, for example, using an OP amplifier (operational amplifier). The comparator 630 is preferably provided in each sensor one by one, so that the slice level of each sensor may be adjusted respectively, and appropriate detection may be made.

The controller 600 controls the sheet feed system 200, the conveyance system 300, the printing part 400, and the detection system 500, and/or communicates therewith. For example, when printing is performed, the controller 600 communicates particularly with the conveyance system 300, so as to control a timely conveyance of the sheets P to the controller 600. To be more specific, the controller 600 controls a motor or other driving means and serves to timely convey the sheet P. When the print mode is changed, the controller 600 controls and communicates with the conveyance system 300 and the printing part 400, and makes the conveyance speed slow (or fast), or the fixing temperature high (or low). The above motor not only denotes a single motor unit (e.g., motor 312, 322, or the like), but also includes a plurality of motors, in some instances. Moreover, the motors 312, 322, 332, and 352 may be independent motors, or one motor that may drive a plurality of rollers.

The controller 600 communicates with the detection system 500 and receives information. The controller 600 also controls each component in the printing part 400, and controls printing operations. Among others, the controller 600 directs the operation panel 140 to display the status of the image-forming device 100, or otherwise.

The image-forming device 100 further includes an open/close guide 120. The open/close guide 120 is pivoted on the shaft of the MFF pick roller 320 so that the open/close guide 120 may pivot within the range as shown in FIG. 6. The open/close guide 120 may preferably rotates independently of the rotation of the MFF pick roller 320. To be specific, the rotation of the pick roller 320 and the open/close guide 120 do not synchronize with each other. In this application, the open/close guide 120 pivots to any position within the above range, and the position where the open/close guide 120 is substantially parallel to the conveyance path of the sheet P is defined as a close position, while the position where the open/close guide 120 is substantially perpendicular to the conveyance path is defined as an open position.

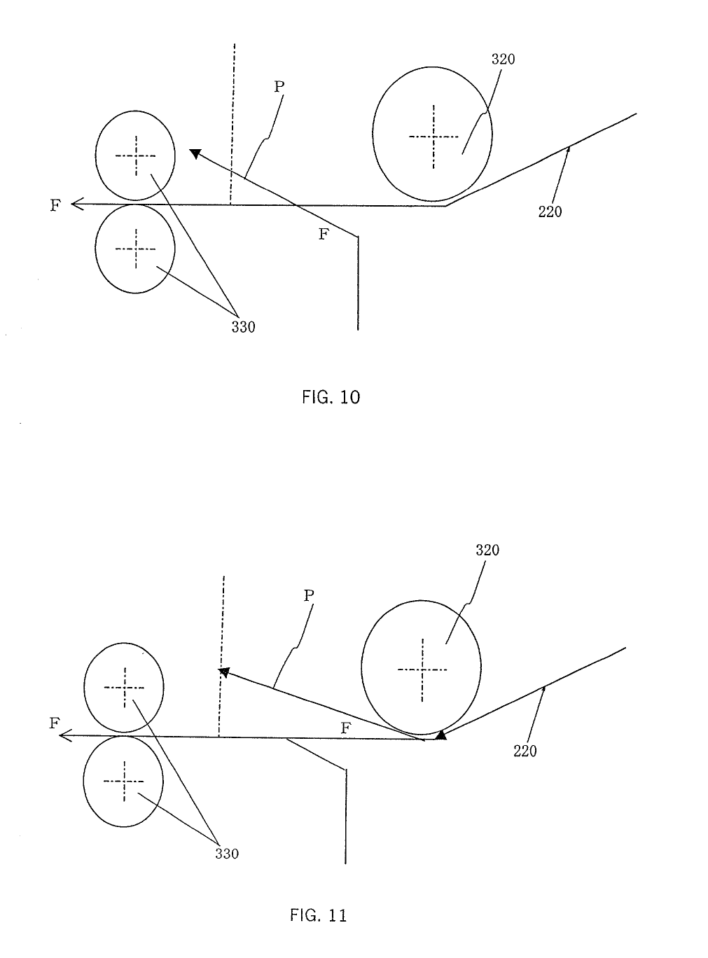

Referring to FIG. 10, when the sheet P conveyed from the cassette 210 passes through the guide 110, the sheet P guided tends to maintain its exit angle, and thus is conveyed in an upward direction relative to the register roller 330. This phenomenon is induced by stiffness of the sheet P, and the OHP sheet, which is higher in stiffness than white paper, has a high propensity for exhibiting this phenomenon. Referring now to FIG. 11, when the sheet P conveyed from the MFF pick roller 320, the sheet P that has passed through the MFF pick roller 320 tends to be bent by a pressing force of the roller 320, and thus is also conveyed in an upward direction relative to the register roller 330. FIGS. 10 and 11 are schematic sectional views of part of the image-forming device 100 for explaining the functions of the open/close guide 120 as shown in FIG. 5. The above-described phenomenon would result in a failure in introducing the sheet P in between the pair of register rollers 330. Therefore, the open/close guide 120 is disposed in the close position so as to forcefully block the sheet P that tends to rise, and corrects the direction of conveyance of the sheet P.

The open/close guide 120 is disposed in the close position in a normal condition (during printing operation). On the other hand, the open position is a position to which the open/close guide 120 is manually pushed away upward by a user or serviceperson to perform services necessary for clearing a jam, etc. or doing maintenance. The open/close guide 120 may be positioned to the open or close position with some force of immobility applied, for example, by a lock means.

A description will be given of the inventive image-forming device 100. The image-forming device 100 receives a print command from a user, and starts a printing operation. The sheets P are placed in both or either of the cassette 210 and/or MFF 220 of the image-forming device 100 (though only one of them is employed for feeding the sheet in actuality). The OHP sheet is placed with its face down in the cassette 210, and with its face up in the MFF 220 so that the printing part 400 may form an image on the face. In the present embodiment, the genuine OHP sheet 10 is placed with its end portion having the identifying mark 30 front.

When the sheets P are placed in the MFF 220, the MFF sheet detection sensor 510 provides an OFF signal. When a signal from the MFF sheet detection sensor 510 is OFF, the controller 600 drives the motor 322 connected with the MFF pick roller 320, and rotates the pick roller 320. If the MFF pick roller 320 is driven using the same motor as the register roller 330, the motor 332 may be used instead. On the contrary, When a signal from the MFF sheet detection sensor 510 is ON, the controller 600 drives the motor 312 connected with the cassette side pick roller 310, and rotates the pick roller 310. Incidentally, when the sheets P are placed both in the cassette and in the MFF 220, the MFF sheet detection sensor 510 provides an OFF signal as well, but in this instance, the controller 600 selects the motor to be driven, by adopting the setting of the printer driver, or by prompting a user to enter his/her choice as to which are to be printed first.

The sheet P fed by the pick rollers 310 and 320 passes through the register sensor 530. The sheet P then passes through the OHP sensor 520, and reaches the register roller 330. The sheet P conveyed by the pick rollers 310 and 320 collides its front end with a nip portion of the register roller 330 at rest. The sheet P is warped to some degree by further pressure from the pick rollers 310 and 320 that continue conveying the sheet P. The warp serves to correct a possible skew of the sheet P.

Next, the controller 600 rotates the register roller 330 with such timing that an image may be printed in a desired position on the sheet P, and conveys the sheet P to the printing part 400. In the sheet feed method using the MFF 220, the same motor 322 may drive the pick roller 310 and the register roller 330, and thus the above step should not be necessarily followed. Because a distance from the MFF pick roller 320 to the register roller 330 is by far shorter in comparison with that from the cassette side pick roller 310. To be more specific, the sheet P fed from the MFF 220 is unlikely to be skewed. Thus, if every sheet is fed from the MFF 220, the separate motor for the pick roller 320 may be dispensed with, and no correction for a skewed sheet is needed. This structure requiring no separate motor is cost-effective.

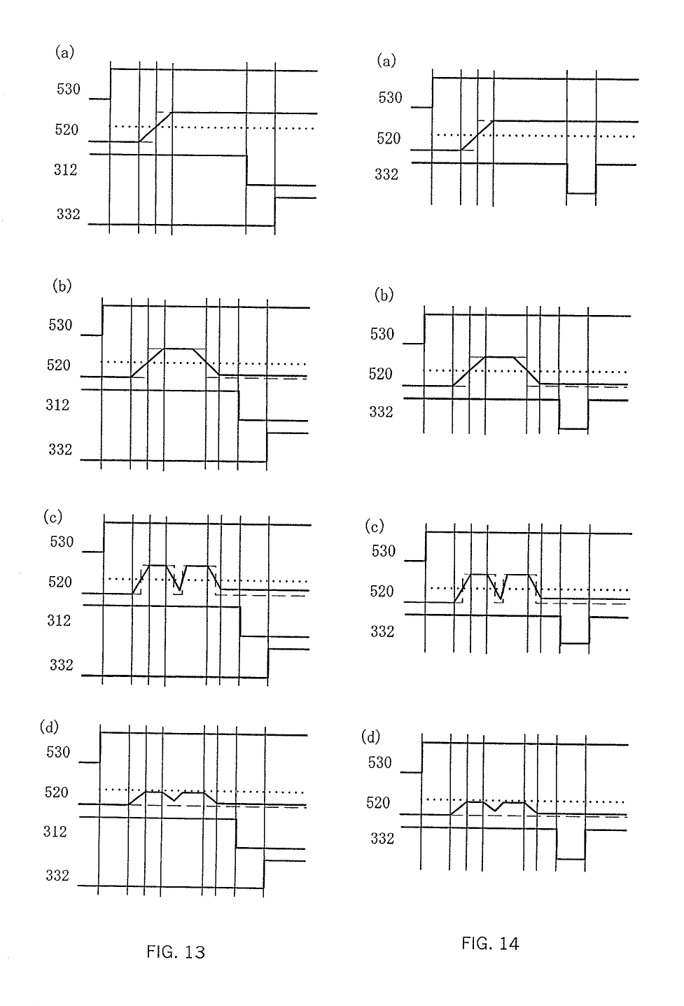

As the above conveyance operation proceeds, the sheet P passes through the register sensor 530 and the OHP sensor 520. When the sheet P passes through the register sensor 530 and the OHP sensor 520, waveforms as shown in FIGS. 13 and 14 are obtained. FIG. 13 is a timing chart for the motors 312, 332 and the sensors 520, 530 when the sensors 530 and 520 detect the sheet P fed from the cassette 210 in the image-forming device 100. FIG. 14 is a timing chart for the motor 332 and the sensors 520, 530 when the sensors 530 and 520 detect the sheet P fed from the MFF 220 in the image-forming device 100.

In FIGS. 13 and 14, (a) denotes a detected waveform of white paper, (b) denotes that of a non-genuine OHP sheet having one stripe, and (c) and (d) denote those of a genuine OHP sheet 10. (c) is a timing chart when the face of the genuine OHP sheet 10 is detected by the sensors 520 and 530. (d) is a timing chart when the back surface of the genuine OHP sheet 10 is detected by the sensors 520 and 530 (i.e., when the sheet P turned upside down is fed). The solid lines in the charts are actually detected waveforms, while the broken lines are waveforms converted through the comparator 630 and recognized by the controller 600. The motors 312 and 332 operate during a time when the electric signal exhibits high (H), and stop during a time when it exhibits low (L). The reason why each waveform for the motors is one and the same type is that the waveform indicates the values when one and the same motor drives both the MFF pick roller 320 and the register roller 330.

Referring to FIGS. 13(c) and 14(c), the OHP sheet 10 has two reflective portions 32 across the direction of conveyance F detected, and generates H signals two times. These two H signals allow the controller 600 to identify the OHP sheet 10. Referring now to FIGS. 13(d) and 14(d), when the OHP sheet 10 is detected from the back surface, a signal generated by detection of the OHP sensor 520 never exceeds the slice level. This is because that side of the identifying mark 30 which is not in contact with the OHP sheet 10 exhibits low reflectance, and therefore the controller 600 in the present embodiment may detect that the OHP sheet 10 is placed with its upside down in the cassette 210 or the MFF 220.

A description will now be given of a method of processing a signal by the controller 600. First, the controller 600 acquires and recognizes output signals from the register sensor 530 and the OHP sensor 520 in a cycle of 477.33×10^{31 6} s. The controller 600 recognizes electric signals that have passed through the comparator 630 and then have been converted into either a high signal (H) or a low signal (L). The controller 600 acquires the output signals from the register sensor 530 and the OHP sensor 520 with the same timing. Moreover, the controller 600 counts the number of acquisitions, and stores the number for the register sensor 530 as a CTR value, and that for the OHP sensor as a CTO value respectively in the RAM 620. The counted numbers are reset every time when L/H signals switch. The controller 600 recognizes only the detection signals of a specific length as an H or L signal, so that such detection signals as to exhibit a momentary H or L value due to debris or the like are excluded.

The above cycle is a phase change cycle of the motors for driving each roller. Checking the sensors in the same cycle as the phase change cycle of the motors permits detection with consideration given to the conveyance speed of the sheet P. Counting the cycle may be realized by connecting a timer with the controller 600. Any timer known in the art may be used. Alternatively, in case the sheet discrimination method of the present invention embodied as a printer driver is loaded in a PC connected with the printer 100, the timer may utilize a system clock incorporated in the PC.

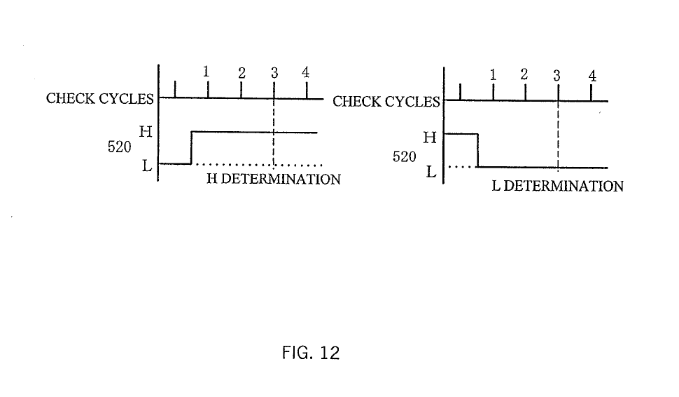

Next, the controller 600 makes an H determination and an L determination, and stores each value in the RAM 620 as an OHPST value. The OHPST value is the number of changes from H to L, or L to H of the signal from the OHP sensor 520. The H determination is to determine a final change of the signal from L to H. Referring to FIG. 12(a), if the controller 600 detects an H signal, and the CTO value is ‘3’, then the controller 600 recognizes the count number as ‘H3’, and makes one H determination. Consequently, the controller 600 recognizes the presence of the H-level signal. Similarly, the L determination is to determine a final change of the signal from H to L. Referring now to FIG. 12(b), if the controller 600 detects an L signal, and the CTO value is ‘3’, then the controller 600 recognizes the count number as ‘L3’, and makes one L determination. Consequently, the controller 600 recognizes the presence of the L-level signal. FIG. 12 is a diagram for explaining an exemplified method of determining an output signal from the OHP sensor 520 by the controller 600.

As described above, the H determination and the L determination are not made until the count number becomes ‘3’, for the purpose of preventing the OHPST value from receiving an increment due to accidental changes in output signals from the OHP sensor 520 induced by diffused reflection or the like. In addition, if the same determinations are successively made (e.g., an H determination follows another H determination), the second or later determination should not be added to the OHPST value. Advantageous effects of these configurations will become apparent in the following description as to an operation. The controller 600 may specify the type of the sheet P by comparing the OHPST value with a specified value stored in the ROM 610.

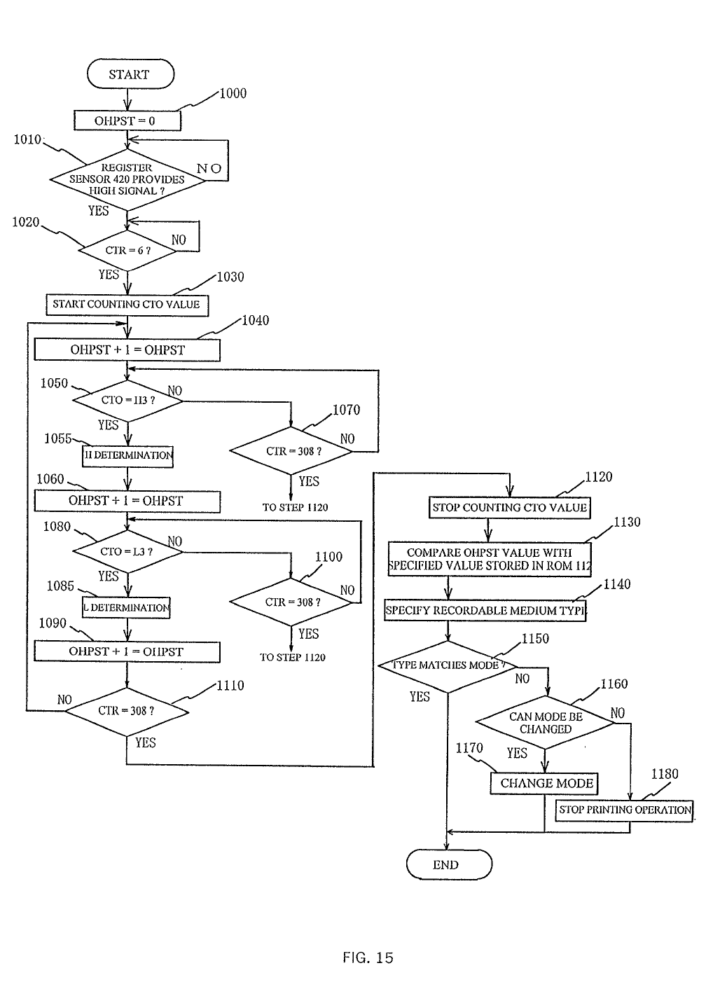

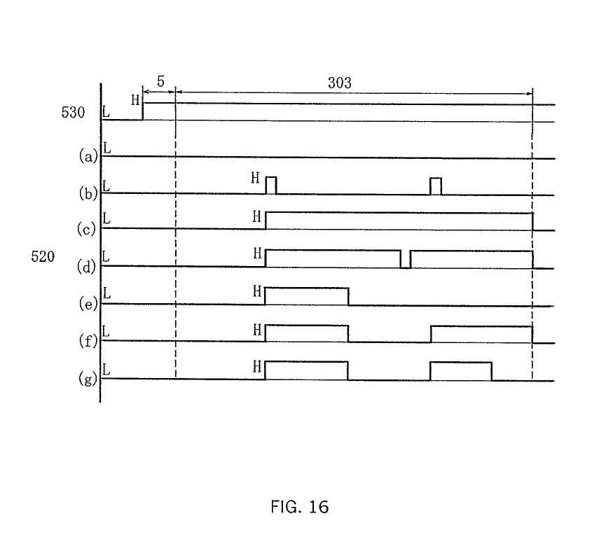

Referring now to FIGS. 15 and 16, a description will be given of a sheet detection operation by the controller 600. FIG. 15 is a flowchart showing a control by the controller 600 when a sheet is detected. FIG. 16 is an exemplified waveform of output signals from the sensors 520 and 530. It is to be understood that the sheet P is fed by the pick roller 310, and being conveyed without suspension. The controller 600 detects output signals from the OHP sensor 520 and the register sensor 530 in the constant cycle (477.33×10^{31 6} s), and determines the outputs from the sensors 520 and 530.

First, the controller 600 initially sets the OHPST value to zero (step 1000). When the sheet P passes through the sensor 530, the output signal of the register sensor 530 becomes H, and the controller 600 detects the H signal (step 1010). Accordingly, the controller 600 determines that the sheet P has passed through the register sensor 530. The controller 600 sets 1 to the H signal detected in step 1010, and monitors the CTR value.

When the controller 600 determines that the H signal is detected (step 1010), and that the CTR value is 6 by looking up the RAM 620 (step 1020), the controller 600 monitors the CTO value by looking up the RAM 620 (1030). The time period required for the CTR value to change from 1 to 6 is about 2.2×10⁻³ s (447.33×10⁻⁶ s×5). In steps 1020 and 1030, the sheet P has not reached the OHP sensor 520 yet, and thus the OHP sensor 520 provides an L signal. The controller 600 recognizes the L signal, and monitors the CTO value. The controller 600 keeps counting the length of the L signals, and therefore even if the CTO value becomes 3, the L determination is not assumed. Because the H and L determinations are made to determine that the change of the output signals from the OHP sensor 520 is finally made, and the values differ from those accompanied by the change of the output signals. Further, the controller 600 monitors the CTO value (step 1030) and adds 1 to the OHPST value (step 1040) at the same time. This is the initial value of the OHPST value.

Next, the controller 600 looks up the RAM 620, and checks whether the CTO value is ‘H3’ (step 1050). This check is carried out every time when the counting is carried out. This is for the purpose of investigating whether the output signal from the OHP sensor 520 is changed from L to H. If the result is Yes in step 1050, then step 1055 and subsequent operations will be carried out.

If the result in step 1050 is No, then the controller 600 checks whether the CTR value is 308 by looking up the RAM 620 (step 1070). ‘308’ is a number corresponding to a time period required for the sheet P that has passed through the register sensor 530 to pass through the detection range H1-H1 of the genuine OHP sheet (308×477.33×10⁻⁶ s=0.15 s). The ‘308’ is the value when the sheet P is fed from the cassette 210, and the value when the sheet P is fed from the MFF 220 is 252 (258×477.33×10⁻⁶ s=0.12 s). These values depend upon the conveyance speed of the pick roller 310, and the present invention is not limited thereto. If the result is No in step 1070, then the operations will go back to step 1050.

On the other hand, if the result is Yes in step 1070, then the controller 600 stops monitoring the CTO value and the CTR value (step 1120). Referring to FIG. 16(a), if the above-described procedural steps are followed, the H and L determinations have not been made, and the OHPST value is ‘1’. FIG. 16(b) is, as well as (a), a specific example of the output signal of the OHP sensor when the above-described procedural steps are followed. In (b), the output signal exhibits High twice. However, the ranges of H are not so continuous that the CTO value becomes ‘H3’, and thus these had better be deemed to be noises. Accordingly, the controller 600 deems that the above ranges of H have not been generated, and the L signals are maintained. Nevertheless, the fact is that the ranges of H are followed by the L signal, and the range of which the CTO value is ‘L3’ is generated. The increment of the OHPST value by the above L determination is not preferable in that the L signals are considered to continue. Therefore, the controller 600 does not increment the OHPST value by determining the continuity conditions. Consequently, irrespective of the above changes, the OHPST value remains ‘1’.

If the result in step 1050 is Yes, the controller 600 makes the H determination, and adds ‘1’ to the OHPST value (steps 1055 and 1060). At that time, the OHPST value is ‘2’. Next, the controller 600 checks whether the CTO value is ‘L3’ (step 1080). This check is carried out every time when the CTO value is counted as in step 1050. This is for the purpose of investigating whether the output signal from the OHP sensor 520 is changed from H to L. If the result is Yes in step 1080, then step 1085 and subsequent operations will be carried out.

If the result in step 1080 is No, then the controller 600 checks whether the CTR value is 308 (step 1110). Since the step 1110 is the same as the above step 1070, a description will be omitted herein. If the result is No in step 1110, then the operations will go back to step 1080.

On the other hand, if the result is Yes in step 1110, then the controller 600 stops monitoring the CTO value and the CTR value (step 1120). Referring to FIG. 16(c), if the above-described procedural steps are followed, only the H determination has been made once, and the OHPST value is ‘2’. FIG. 16(d) is, as well as (c), a specific example of the output signal of the OHP sensor 520 when the above-described procedural steps are followed. In (d), the output signal exhibits Low once. However, the ranges of L are not so continuous that the CTO value becomes ‘L3’, and thus these had better be deemed to be noises. Accordingly, the controller 600 deems that the above ranges of L have not been generated, and the H signals are maintained; thus, the OHPST value remains ‘2’.

If the result in step 1080 is Yes, the controller 600 makes the L determination, and adds ‘1’ to the OHPST value (steps 1085 and 1090). At that time, the OHPST value is ‘3’. Next, the controller 600 checks whether the CTR value is 308 (step 1110). If the result is Yes in step 1110, the controller 600 stops monitoring the CTO value and the CTR value (step 1120). Referring to FIG. 16(e), if the above-described procedural steps are followed, the H determination of the H and L determinations has been alternately made once respectively, and the OHPST value is ‘3’. In FIG. 16(e) (though not shown), when partial signal changes considered to be noises or the like are detected, the OHPST value is not incremented as above.

If the result is No in step 1110, the operations go to the step 1050, and repeat the same process. The repeated process would increment the OHPST value. FIG. 16(f) is a specific example of the output signals that exhibit the H determination twice and the L determination once. In (f), the OHPST value is ‘4’. FIG. 16(g) is a specific example of the output signals that exhibit the H determination twice and the L determination twice. In (g), the OHPST value is ‘5’.

When the step 1120 is complete, then the controller 600 compares the OHPST value with a specified value stored in the ROM 610 (step 1130). The specified value is a predetermined OHPST value corresponding to the sheet. The various specified values are explained below. The OHPST values in odd numbers denote OHP sheets. However, as an exception, ‘1’ particularly denotes such OHP sheets as turned upside down or front side rear, or without stripes. In addition, ‘5’ particularly denotes such OHP sheets as recognized as genuine OHP sheets. The OHPST values in even numbers denote white paper. The controller 600 compares the detected OHPST value with these values and specifies the type of the sheet P (step 1140).

Next, the controller 600 determines whether the specified type of the sheet P matches the print mode (step 1150). If the result is Yes in step 1150, the image-forming device 100 continues the printing operation. On the other hand, if the result is No, the controller 600 checks whether the mode can be changed (step 1160). When the specified sheet P is considered to be printable in the print modes of the inventive image-forming device 100, the result should be Yes in this step. When the specified sheet P is not considered to be printable in the print modes of the inventive image-forming device 100, the result should be No in this step in that the image-forming device 100 has no optimal print mode. Such determination of No in this step is made, for example, when the sheet P is an OHP sheet other than the OHP sheet 10.

If the result is Yes in step 1160, the controller 600 changes the print mode into an optimal mode for the sheet P (step 1170), and continues the printing operation. If the result is No in step 1160, the controller 600 stops the printing operation (step 1180). In that event, the image-forming device 100 is preferably configured to raise an alarm, or displays that the printing operation is suspended in an operation panel, to notify a user of the status. In response thereto, the user may replace the sheet P with white paper or the OHP sheet 10, and retry the printing operation.

The sheet P after the sheet type identification and skew correction processes is conveyed to the printing part 400 as the register roller 330 rotates. Thereafter, the sheet P is electrostatically adsorbed to the conveyor belt 340 that rotates to the left by the driving roller 350b and the photosensitive drum 420, and conveyed between the photosensitive drum 420 and the conveyor belt 340 in the process unit 410. To be specific, the sheet P has a toner layer formed by the image-forming device 100 in the sequence of yellow, magenta, cyan, and black each corresponding a desired image, during conveyance by the conveyor belt 340 and the driven roller 350. The toner layer is then fixed on the sheet P using the fixer 430. Thereafter, the sheet P on which the toner layer has been fixed is ejected to the stacker. Through these procedural steps, the controller 600 control each operation of the sheet feed system 200, the conveyance system 300, and the printing part 400 so as to conform to the print mode.

Although the preferred embodiments of the present invention have been described above, various modifications and changes may be made in the present invention without departing from the spirit and scope thereof.

As described above, the inventive transparent recordable medium has a mark of high reflectance to be used for an identifying mark, so that an optical sensor may detect the mark, even if the mark only provides a short range of detection. In addition, the optical sensor can distinguish a genuine transparent recordable medium from non-genuine transparent recordable medium, by detecting more than one reflection from the identifying mark.

Furthermore, the inventive image-forming device can effectively distinguish the genuine transparent recordable medium from others, and thus can print a high-quality image on the transparent recordable medium. Consequently, the image-forming device may provide a user with a high-quality printed matter. The inventive identification device can distinguish a genuine transparent recordable medium from others.

What is claimed is:

1. An image-forming device comprising:
a detection part that optically senses within a predetermined detection range a non-printable area on a transparent recordable medium, wherein the transparent recordable medium includes a printable area comprised of a transparent part through which light passes, and in which information is to be recorded, and the non-printable area in which recording of the information is prohibited;
a printing part that performs printing on the transparent recordable medium; and
a controller that determines whether the transparent recordable medium is a dedicated product expected to be exclusively used in combination with the image-forming device based upon the number of changes in value detected by the detection part within the detection range, and that enables the printing part to perform printing on the transparent recordable medium identified as the dedicated product.

2. An image-forming device comprising:
a detection part that senses within a predetermined detection range a non-printable area on a transparent recordable medium, wherein the recordable medium includes a printable area in which information is to be recorded, and the non-printable area in which recording of the information is prohibited;
a printing part that performs printing on the recordable medium; and
a controller that identifies the recordable medium as any one among a plurality of types including a dedicated product expected to be exclusively used in combination with the image-forming device based upon the number of changes in value detected by the detection part within the detection range, and that controls printing conditions in the printing part according to the type of the recordable medium identified.

3. An image-forming device according to claim 2, wherein the controller identifies the recordable medium as any one among at least three types, including:
white paper;
a transparent recordable medium that is the dedicated product; and
a transparent recordable medium that is not the dedicated product,
wherein the printable area in the transparent recordable medium is a transparent part through which light passes.

4. An image-forming device according to claim 3, wherein the controller stops printing by the printing part when the recordable medium identified is that which is not the dedicated product.

5. An identification device comprising:
a detection part that optically senses within a predetermined detection range a non-printable area on a transparent recordable medium, wherein the transparent recordable medium includes a printable area comprised of a transparent part in which an image-forming device is allowed to record information, and through which light passes, and the non-printable area in which the image-forming device is prohibited from recording the information; and
a determination part that determines whether the transparent recordable medium is a dedicated product expected to be exclusively used in combination with the image-forming device based upon the number of changes in value detected by the detection part within the detection range.

6. A transparent recordable medium comprising:
a printable area that includes a transparent part through which light passes, and in which an image-forming device is allowed to record information; and
a non-printable area in which the image-forming device is not allowed to record the information,
wherein the non-printable area includes an identifying mark having reflectance 1.2 times or higher the reflectance of white paper, to indicate that the transparent recordable medium is a dedicated product expected to be exclusively used in combination with the image-forming device, wherein the reflectance of the identifying mark is detected with a light incident angle that is the same as that of the white paper.
